(19) United States
(12) Patent Application Publication
(10) Pub. No.: US 2002/0049538 A1
(43) Pub. Date: Apr. 25, 2002

(54) Vehicle tracking systems and methods

(76) Inventors: Cary Paul Knapton, Child Okeford (GB); Paul Anthony Collins, Frome (GB)

Correspondence Address: DOWELL & DOWELL PC, SUITE 309, 1215 JEFFERSON DAVIS HIGHWAY, ARLINGTON, VA, 22202

(21) Appl. No.: 09/960,888

(22) Filed: Sep. 24, 2001

(30) Foreign Application Priority Data
Oct. 23, 2000 (GB) 0025900.2

(51) Int. Cl. G01S 1/00

(52) U.S. Cl. 701/216; 342/357.07

(57) ABSTRACT

Vehicle tracking systems and methods are provided. A Global Positioning System (GPS) receiver is operative to generate first, GPS, data identifying the vehicle's current position from GPS signals. An On Board Diagnostics (OBD) Hardware Interface is operative to generate second, OBD, data identifying the vehicle's current position by using dead reckoning techniques. Arbitration means are provided to arbitrate between the first and second data by performing integrity checks thereon to generate data giving an improved identification of the vehicle's current position.

### FIELD OF THE INVENTION

This invention relates to vehicle tracking systems and methods.

### BACKGROUND OF THE INVENTION

In recent years, the Global Positioning System (GPS) has been developed as a means of identifying a vehicle's current position. There have, in fact, been numerous tracking systems utilising Global Positioning System (GPS) technology. These systems are, however, limited in their ability to accurately, and at all times, track position and distance travelled since harsh weather, atmospheric conditions, solar activity and tree cover or other terrain-related aspects have an adverse effect on the reception of a GPS signal. That therefore limits the ability of a Global Positioning System to produce accurate and reliable information at all times.

### SUMMARY OF THE INVENTION

One broad aspect of the invention provides a vehicle tracking system comprising:

a Global Positioning System (GPS) receiver operative to generate first, GPS, data identifying the vehicle's current position from GPS signals;

an On Board Diagnostics (OBD) Hardware Interface operative to generate second, OBD, data identifying the vehicle's current position by using dead reckoning techniques; and

arbitration means to arbitrate between the first and second data by performing integrity checks thereon to generate data giving an improved identification of the vehicle's current position.

Another broad aspect of the invention provides a method of vehicle tracking comprising:

using a Global Positioning System (GPS) receiver to generate first, GPS, data identifying the vehicle's current position from GPS signals;

using an On Board Diagnostics (OBD) Hardware Interface to generate second, OBD, data identifying the vehicle's current position by using dead reckoning techniques; and

using arbitration means to arbitrate between the first and second data by performing integrity checks thereon to generate data giving an improved identification of the vehicle's current position.

By utilizing two sets of data from different sources and arbitrating between them, better identification of the vehicle's current position is possible then when either is used alone. The arbitration means can be used to provide data locally, utilizing industry standard communications techniques, or remotely, to provide data to one or more external systems in real-time or at predetermined times, for subsequent processing and analysis.

Global Positioning Systems are capable of identifying not only a vehicle's current position but also real-time date and time

OBD Hardware Interfaces are capable of obtaining. vehicle data in bit and byte format to calculate distance travelled. They are readily available and utilize standards defined in the 1999 edition of the standard SAE HS-3000. An example of an OBD Hardware Interfaces which may be used is that defined by the standard SAE J1962 for a physical diagnostic interface and using, for example, standard SAE J1850 Data Communications, ISO 1941-2 Data Communications, ISO 14230-4, ISO 11898, SAE J2284 CAN2.0 physical and electrical standards within that specification.

Dead reckoning using an OBD Hardware Interface is possible by making use of, for example, the standard SAE J2178 for Steering and Suspension PRN assignments, for example, PRN 3001, 300E, 3801, 3802, 3803, 380B, 380C.

The invention may be used to allow real-time data to be uploaded or downloaded to a microcomputer or network based server using Internet Protocol or other standard through a standard data communications interface, either locally or remotely using wire or wireless techniques.

Advantageously, the system includes means to provide an in-vehicle navigation system. In-vehicle navigation systems are known per se and the invention permits a known form of in-vehicle navigation display to be supplied with source data providing a better identification of the vehicle's current position.

Preferably, the arbitration means is operative to select GPS data in preference to OBD data when a valid GPS lock-on is detected.

Advantageously, the arbitration means comprises a micro-controller or microprocessor with associated memory and a real-time clock.

Preferably, the arbitration means is synchronized to the GPS clock, and is programmed to combine together the GPS and OBD data, to store the resultant data on a regular basis, and to perform calculations upon the data.

The system may further include a mobile radio system for sending data to and from the arbitration means.

Preferably, the mobile radio system comprises a short range and long range radio system. By that means it is possible to take data to and from the arbitration means and communicate it using short range or long range mobile data, for example, by means of the techniques known as Bluetooth™, GSM, GPRS, UMTS and/or PMR to connect to a network based microcomputer or server.

Advantageously, the mobile radio system is operative to communicate using a standard protocol.

The standard protocol may be the Internet Protocol.

Preferably, the OBD Hardware Interface is arranged to collect vehicle data from the vehicle's integral on board diagnostics hardware interface to calculate and establish distance travelled and position.

Distance travelled may be calculated from the GPS data using either real-time or stored positional readings.

Advantageously, a user's operation of the vehicle throttle is used to provide an input signal to the system.

The use of the throttle or other control of the vehicle to provide a signal input from the user is, however, capable of more general application.

The invention also provides a vehicle computation system comprising an OBD hardware Interface to receive signals produced by the controls of the vehicle, and computation means for performing computations based on data supplied by the OBD Hardware Interface, wherein a control means of the vehicle is used to enable the user to provide a signal input to the computation means via the OBD Hardware interface, the signal representing data of different significance from the normal function of the control means in controlling the vehicle.

The invention also provides a corresponding method of signalling in a vehicle computation system.

The computation system may be an expense form generation system.

The control means may be the throttle control of the vehicle.

The control means may be used in combination with a second control means of the vehicle to provide the said signal.

The second control means may be the ignition control of the vehicle.

The signal may represent the start and/or end of a journey.

Advantageously, the system includes means to generate an expense form from the output of the arbitration means.

There has been a significant increase in fuel prices over recent years which necessitates that employers and employees keep accurate records when travelling on business to ensure fair compensation for journeys carried out by employees. Additionally, tax authorities throughout the world are tending to demand a higher level of accurate documentation to justify genuine business mileage.

Furthermore, insurance premiums have increased significantly owing to litigation through injury, theft and accident claims in which blame cannot be apportioned through lack of exact information on the position of a vehicle at a given time.

The invention is capable of providing a system which automatically logs date and time, geographical position at the start and finish of a journey, journey category and allows distance travelled to be accurately measured. The system can then automatically create an “expense claim form” utilising all of this gathered data either locally or remotely from the vehicle. Furthermore, the journey can be tracked by identifying geographical positions throughout the duration of the journey allowing the route to be graphically viewed and evaluated by either the employer or employee or other approved body or individual during or after completion of the journey.

The invention can also be employed to allow data acquisition of the vehicle for the use of, for example, Insurance Companies, Employers, Garages, Motor Manufacturers, Individuals and Statutory authorities, for evaluation by individuals or other authorized bodies to establish vehicle malfunctions, set insurance premiums, or establish cost savings or the cause of an accident or injury claim or other requirement.

Where lower accuracy of expense forming is acceptable, for example, for private purposes, the arbitration means may be omitted and the expense form generated on the basis of data from a GPS receiver or OBD Hardware Interface alone.

The invention provides an expense form generation system comprising:

a Global Positioning System (GPS) receiver operative to generate first, GPS, data identifying the vehicle's current position; and

computation means for generating an expense form based on data from the Global Positioning System receiver.

The invention also provides an expense form generation system comprising:

an On Board Diagnostics (OBD) Hardware Interface operative to generate second, OBD, data identifying the vehicle's current position by using dead reckoning techniques; and

computation means for generating an expense form based on data from the Global Positioning System receiver.

An expense form may be generated according to the invention by a method corresponding to a system of the invention.

### BRIEF DESCRIPTION OF THE DRAWINGS

Vehicle tracking systems and methods in accordance with the invention will now be described, by way of example only, with reference to the accompanying drawings in which:

FIG. 1 shows a block schematic diagram of a first vehicle tracking system in accordance with the invention;

FIG. 2 shows a block schematic diagram of an expense form generation system constituting a second vehicle tracking system in accordance with the invention;

FIG. 3 is a pictorial representation of the operation of the expense form system of FIG. 2 to retrieve and/or to store data of logged journey and vehicle management information remotely from the vehicle in order to view and create an expense claim form and deliver vehicle management data remotely from the vehicle;

FIG. 4 is a pictorial representation of a modification of the system of FIG. 2 in which logged journey information is used to create an expense claim form local to the vehicle.

### DETAILED DESCRIPTION OF THE PREFERRED EMBODIMENTS

Referring to the accompanying drawings, a vehicle tracking system 1 comprises a Global Positioning System (GPS) receiver 2 operative to generate first, GPS, data identifying the vehicle's current position; an On Board Diagnostics (OBD) Hardware Interface 3 operative to generate second, OBD, data identifying the vehicle's current position by using dead reckoning techniques; and arbitration means 4 to arbitrate between the first and second data by performing integrity checks thereon to generate data giving an improved identification of the vehicle's current position. The arbitration means 4 comprises a micro-controller or microprocessor with associated memory and a real-time clock.

The arbitration means 4 is synchronized to the GPS clock, and is programmed to combine together the GPS and OBD data, to store this data on a regular basis, and to perform calculations upon the data.

A mobile radio system 5 is provided for sending data to and from the arbitration means 4. Antennae 6 are provided for the GPS receiver 2 and the mobile radio system 5. The mobile radio system 5 comprises a short range and long range radio system (not specifically illustrated) and is operative to communicate using a standard protocol, preferably, the Internet Protocol.

The OBD Hardware Interface 3 is arranged to collect vehicle data from the vehicle's integral on board diagnostics hardware interface in order to calculate and establish distance travelled and position.

Distance travelled can be calculated from the GPS data using real-time or stored positional readings.

An On Board Diagnostics (OBD) Interface connector 7 is provided to power and pass signals to and from the tracking system 1 as indicated by the double-ended arrow 8. The connector 7 is in accordance with specification SAE J1962 or other suitable physical interface device.

In operation, the SAE J1962 connector 7 or other physical interface is polled by the micro-controller of the arbitration means 4 by means of the OBD Hardware Interface 3 for a mode $01 PID 11 (throttle position) or other valid response codes utilizing, for example, the SAE J1962 physical diagnostic interface using SAE J1850 Data Communications, ISO 1941-2 Data Communications, ISO 14230-4, ISO 11898, SAE J2284 CAN2.0 physical and electrical standards.

If an invalid response is received, the microcontroller constituting the arbitration means 4 continues to poll the interface connector 7 by means of the OBD Hardware Interface 3 at pre-defined set intervals until the vehicle ignition is activated and a valid response is received via the J1962 connector 7.

Once a valid response is received, the microcontroller of the arbitration means 4 activates the GPS for NMEA data to establish date, time, and positional information, and continues to poll with Mode $01 PID 11 or equivalent valid code at predetermined times until an invalid response is received from the OBD hardware 2 resulting from the switching off of the vehicle's ignition, that switching-off indicating the end of the journey.

All relevant data is saved into the memory of the micro-controller constituting the arbitration means 4. The data is recoverable for processing and/or analysis using an industry standard data communications interface 9 locally or remotely using short range and long range mobile radio 5 via antennae 6 to connect to a network-based microcomputer or server using the Internet Protocol standard.

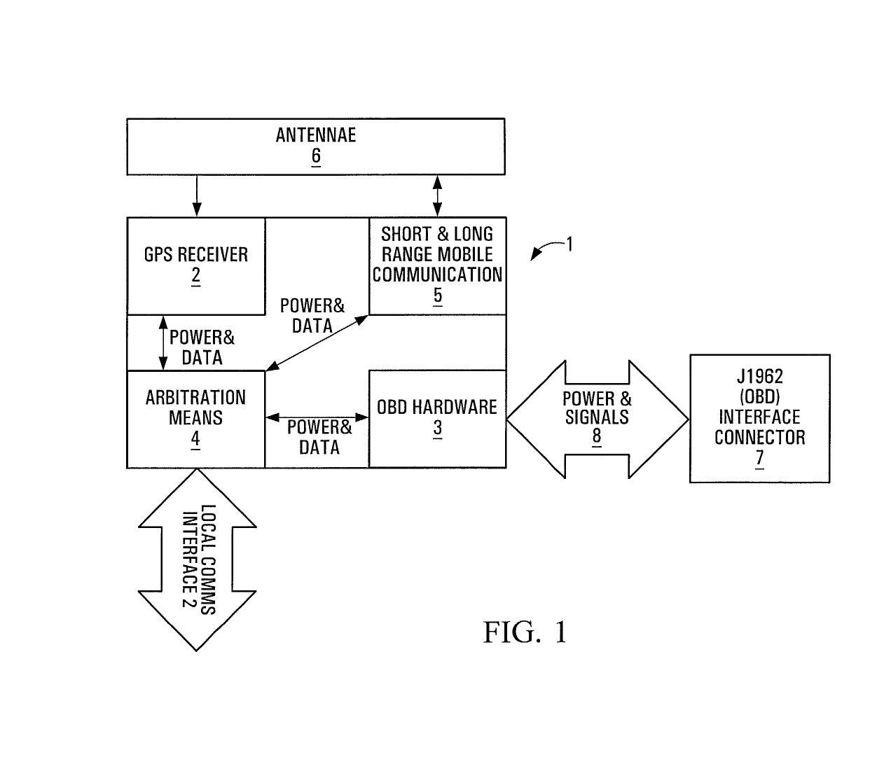

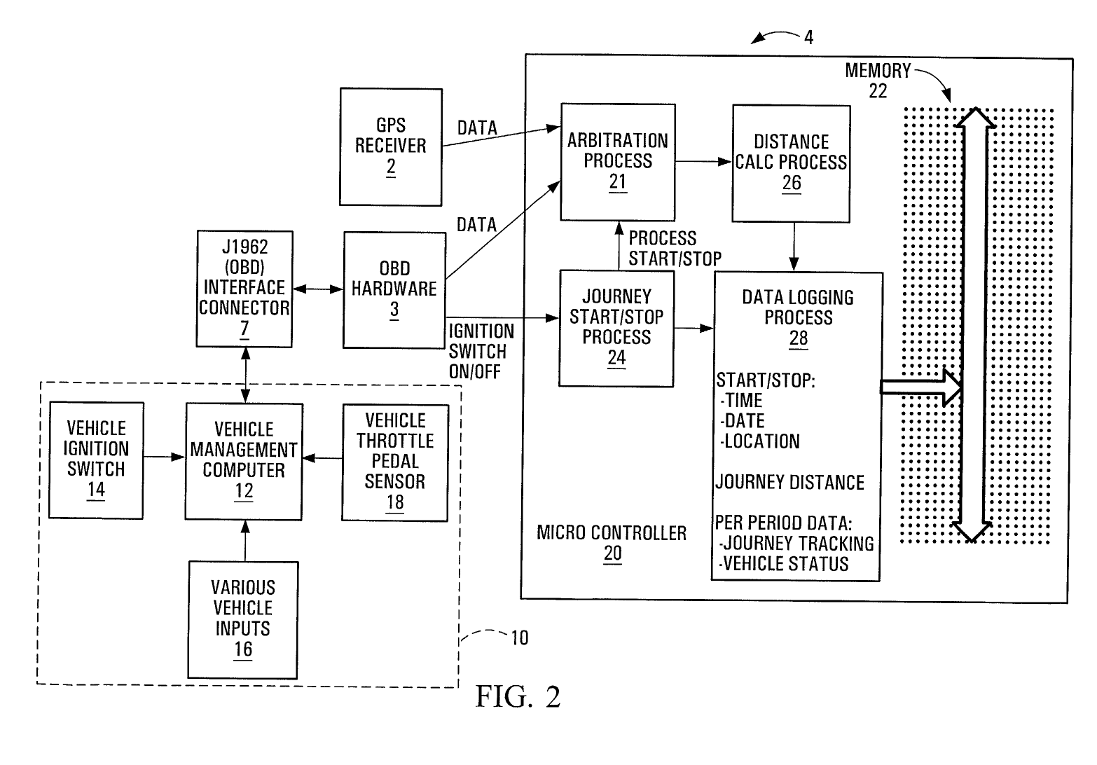

Referring to FIG. 2, a second embodiment of the invention comprising an expense form generation system is shown. Components of the expense form generation system which correspond to components of FIG. 1 are given like reference numerals and will not be described again in detail. The system of FIG. 2 includes means to generate an expense form from the output of the arbitration means 4.

FIG. 2 shows an expense form system with onboard data acquisition for calculating distance travelled, journey start time, journey start position, journey finish time, journey finish position, and category of journey.

The expense form system of FIG. 2 is an automated vehicle tracking system with onboard data acquisition in which the hardware and software allow real-time or predetermined collection of vehicle data through the vehicle's integral on board diagnostics hardware interface to be communicated using the short range and long range mobile radio system 5 of FIG. 1 using Internet protocol or other standard.

Components 10 shown within a broken line box are part of the normal equipment of the vehicle and comprise a vehicle management computer 12, a vehicle ignition switch 14, various vehicle inputs 16 (which being of a standard nature do not need to be listed individually), and a vehicle throttle pedal sensor 18 which is used for a special purpose in the invention.

The arbitration process is shown as block 21 in FIG. 2 as one of the processes carried out by a micro-controller provided with memory 22 and constituting the arbitration means 4. Other procedures carried out by the micro controller 20 are represented by the blocks Journey Start/Stop process 24, Distance calculation process 26, and Data Logging process 28.

In the operation of the expense form generation system of FIG. 2, the start of a journey is defined when the micro-controller 22 constituting the arbitration means 4 receives, via the OBD Hardware Interface 3, a valid response from the interface connector 7, that valid response being produced when the ignition is switched on (as previously described with reference to FIG. 1). That activates the Data Logging process (using NMEA signals) via the micro-controller 20 constituting the arbitration means 4 which defines the logged on time by means of information from the GPS receiver 2 which provides the universal date and time and position. This information, date, time and position, defines the start of the journey and is saved into the micro-controller's memory 22.

The output of a valid OBD response from Mode $01 PID 11, or other throttle position response, is used to define the category of the journey by the relevant position of the throttle when the ignition is switched on. At the same time as a valid response from the OBD Hardware Interface 2 is received, the GPS 1 receiver 2 is activated and NMEA responses are monitored for current position at predetermined intervals, with a calculation taking place every time an updated NMEA response is received in order to work out the cumulative distance travelled.

Arbitration is carried out by the micro-controller 20 constituting the arbitration means 4 to decide whether the GPS receiver 2 has a valid data lock-on, and to determine whether the vehicle is stationary by making use of the OBD Hardware Interface 3 response to the Mode $01 PID 0D poll. If the GPS receiver 2 data is not valid, or the vehicle is stationary as defined by the Mode $01 poll receiving byte 0, the Micro-controller 20 utilizes the OBD Hardware Interface 3 readings to carry out a calculation from the Mode $01 PID 0D response, or, provided that the vehicle supports it, from standard SAE J2178-2 Driver Information assignments (PRNS 6001, 6002, 6004, 601E, 6031, 6032, 6033, 6034, 6039) responses to identify the distance travelled, and uses standard SAE 2178-2, provided that the vehicle supports it, Steering and Suspension PRN assignments PRN 3001, 300E, 3801, 3802, 3803, 380B, 380C, to calculate the current position of the vehicle at any point in time using dead reckoning techniques. The micro-controller 20 constituting the arbitration means 4 continues to calculate the cumulative distance travelled and position until a valid data lock-on response is received from the GPS 1 NMEA data or the Mode 01 PID 0D response goes to a byte >0 at which time obtaining of the distance travelled variable by OBD is changed to obtaining the distance travelled variable by GPS which then continues to be used for monitoring the cumulative distance travelled.

If a valid GPS satellite lock is lost during the journey, the obtaining of the distance travelled variable is changed back to OBD, and the process of arbitration continues in a like manner until the journey's end.

The end of the journey is defined when the ignition is switched off, which switching-off results in no response being received from the OBD Hardware Interface 3, at this point, a process is activated which saves the current GPS universal date, time and position to memory 9.

A data acquisition process is optionally included which is carried out using the technology already described in FIG. 1 but which additionally polls the J1962 interface connector 7 via the OBD Hardware Interface 3 as described in FIG. 1 in real-time or at predetermined intervals to establish data which would be of use in establishing driving habits using PRN information described in standard SAE 2178 or Mode$01 PID information, the cause of an accident, or identifying if the vehicle requires service, or has a malfunction (using diagnostic trouble codes as defined in standard SAE 2012). That information is stored in the micro-controller's memory 22 for evaluation in the event of an incident or if the vehicle has a malfunction or is in need of service.

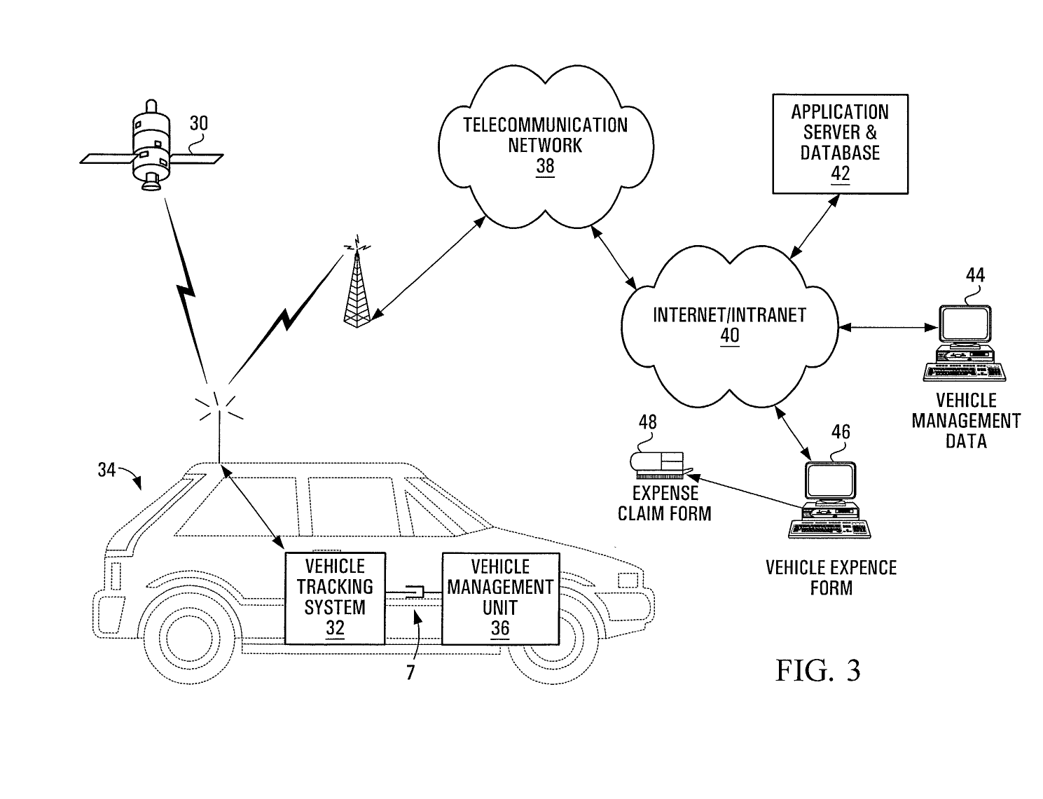

FIG. 3 shows a satellite 30 communicating with a vehicle tracking system 32 in accordance with FIG. 2 installed in a vehicle 34 having a vehicle management unit 36. Communication is also shown over a telecommunications network 38,and Internet and/or Intranet 40 to and from an application server and database 42, a computer 44 communicating vehicle management data provided by the use of the invention, a computer 46 communicating vehicle expense data provided by the use of the invention and a printer 48 generating an expense claim form. The drawing is essentially pictorial and if desired the functions of computers 44 and 46 can be provided on a single computer. The computers 44 and 46 are standard computers with an Internet and/or Intranet connection and are not required to run any additional software for the purposes of the invention.

By combining the positional information with distance travelled information as described in FIG. 2, with the logged on and logged off information, and journey category the basic accurate data to claim expenses for that particular journey and vehicle management data becomes resident in the micro-controller's memory 22. That data can be recovered in either in real-time or at predetermined intervals from a number of journeys for processing and/or analysis remotely using short range and long range mobile radio 5 to connect to a network based microcomputer or server using the Internet Protocol standard.

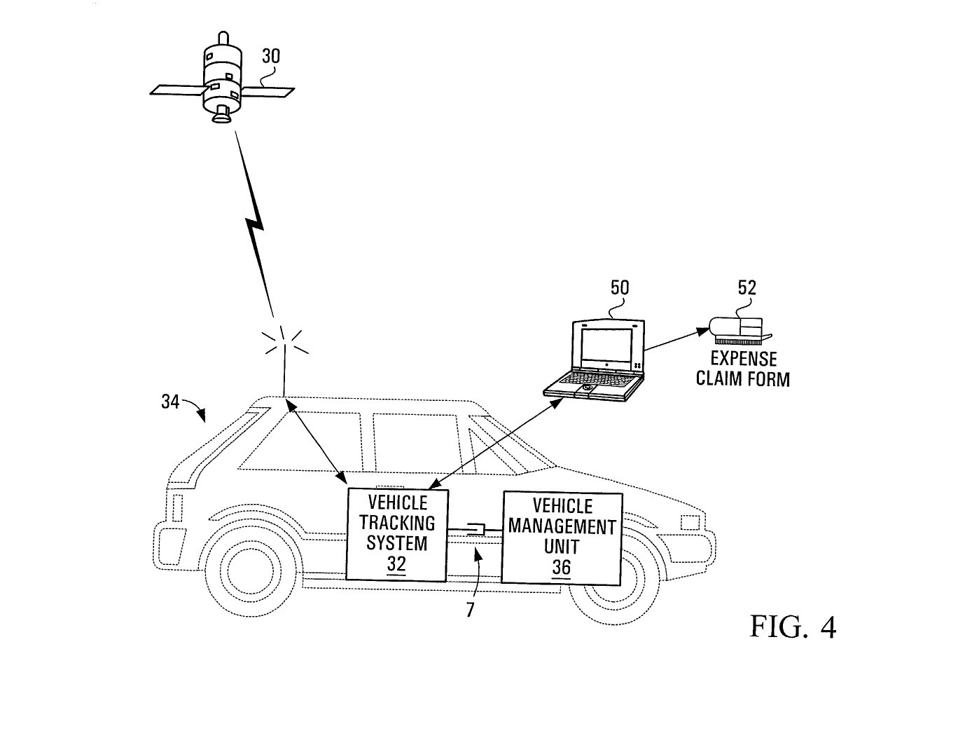

FIG. 4 shows a modification of FIG. 3 in which a portable computer 50 and portable printer 52 are used to produce an expense claim form local to the vehicle 34.

By combining the positional information with distance travelled information as described in FIG. 2, with the logged on and logged off information, and journey category, the basic accurate data to claim expenses for that particular journey and vehicle management data becomes resident in the micro-controllers memory 22. In FIG. 4, this information is retrieved using the industry standard data communications interface 9 (FIG. 1) locally to create an expense claim form by the portable, for example, a laptop, computer 50 or similar device for printing on the printer 52.

An example will now be given of a method of carrying out the invention.

### EXAMPLE

To track a journey and display expense claim and acquired data details:

Install GPS/Mobile antennae 6 onto vehicle and connect to tracking system 1 in FIG. 1

Connect the male J1962 connector 7 or other physical connection in FIG. 1 into female J1962 connector or other physical connection on the vehicle 34 (FIG. 3)

Depress the vehicle throttle towards the floor to select category of journey or leave foot off of the throttle to select default category, turn on the ignition without starting the engine, remove foot from throttle.

Start Engine and Proceed to Destination

Stop Engine

Extract the data to a server or microcomputer from the unit by means of current industry standard data communications techniques either locally by wire (FIG. 4) or remotely by wireless system (FIG. 3)

Display the journey expense claim data and/or print acquired data utilising a microcomputer or other computer with a database or other suitable application

Components used in the described and illustrated embodiments of the invention can be used to provide the user of the vehicle with access to the Internet, for example, by means of the user connecting a portable computer or mobile phone to a system of the invention.

1. A vehicle tracking system comprising:
a Global Positioning System (GPS) receiver operative to generate first, GPS, data identifying the vehicle's current position from GPS signals;
an On Board Diagnostics (OBD) Hardware Interface operative to generate second, OBD, data identifying the vehicle's current position by using dead reckoning techniques; and
arbitration means to arbitrate between the first and second data by performing integrity checks thereon to generate data giving an improved identification of the vehicle's current position.

2. A system as claimed in claim 1, wherein the system further comprises means to provide an in-vehicle navigation system.

3. A system as claimed in claim 1, wherein the arbitration means is operative to select GPS data in preference to OBD data when a valid GPS lock-on is detected.

4. A system as claimed in claim 1, wherein the arbitration means comprises a micro-controller or microprocessor with associated memory and a real-time clock.

5. A system as claimed in claim 4, wherein the arbitration means is synchronized to the GPS clock, and is programmed to combine together the GPS and OBD data, to store the resultant data on a regular basis, and to perform calculations upon the data.

6. A system as claimed in claim 1, further including a mobile radio system for sending data to and from the arbitration means.

7. A system as claimed in claim 6, wherein the mobile radio system comprises a short range and long range radio system.

8. A system as claimed in claim 6, wherein the mobile radio system is operative to communicate using a standard protocol.

9. A system as claimed in claim 8, wherein the standard protocol is the Internet Protocol.

10. A system as claimed claim 1, wherein the OBD Hardware Interface is arranged to collect vehicle data from the vehicle's integral on board diagnostics hardware interface to calculate and establish distance travelled and position.

11. A system as claimed in claim 1, wherein distance travelled is calculated from the GPS data using real-time positional readings.

12. A system as claimed in claim 10, wherein distance travelled is calculated from the GPS data using real-time positional readings.

13. A system as claimed in claim 1, wherein distance travelled is calculated from the GPS data using stored positional readings.

14. A system as claimed in claim 10, wherein distance travelled is calculated from the GPS data using stored positional readings.

15. A system as claimed in claim 1, wherein user's operation of the vehicle throttle is used to provide an input signal to the system.

16. A system as claimed claim 1, wherein the system includes means to generate an expense form from the output of the arbitration means.

17. A system as claimed in claim 1, wherein the system provides a connection to the Internet for a user of the vehicle.

18. A method of vehicle tracking comprising:
using a Global Positioning System (GPS) receiver to generate first, GPS, data identifying the vehicle's current position from GPS signals;
using an On Board Diagnostics (OBD) Hardware Interface to generate second, OBD, data identifying the vehicle's current position by using dead reckoning techniques; and
using arbitration means to arbitrate between the first and second data by performing integrity checks thereon to generate data giving an improved identification of the vehicle's current position.

19. A vehicle computation system comprising an OBD hardware Interface to receive signals produced by the controls of the vehicle, and computation means for performing computations based on data supplied by the OBD Hardware Interface, wherein a control means of the vehicle is used to enable the user to provide a signal input to the computation means via the OBD Hardware interface, the signal representing data of different significance from the normal function of the control means in controlling the vehicle.

20. An expense form generation system comprising:
a Global Positioning System (GPS) receiver operative to generate first, GPS, data identifying the vehicle's current position; and
computation means for generating an expense form based on data from the Global Positioning System receiver.

21. An expense form generation system comprising:
an On Board Diagnostics (OBD) Hardware Interface operative to generate second, OBD, data identifying the vehicle's current position by using dead reckoning techniques; and
computation means for generating an expense form based on data from the Global Positioning System receiver.
